(19) United States
(12) Patent Application Publication
(10) Pub. No.: US 2015/0183374 A1
(43) Pub. Date: Jul. 2, 2015

(54) Auxiliary Mirror Device for Vehicles

(71) Applicant: Hsin-I Liu, Tainan City (TW)

(72) Inventor: Hsin-I Liu, Tainan City (TW)

(21) Appl. No.: 14/143,013

(22) Filed: Dec. 30, 2013

(51) Int. Cl. B60R 1/078

(52) U.S. Cl. CPC B60R 1/078

(57) ABSTRACT

An auxiliary mirror device for vehicles includes a fixation unit, a connection rod unit, and an auxiliary mirror. The fixation unit is adapted for coupling on a frame of a vehicle side view mirror. The connection rod unit includes a connection rod coupled inside a holder base of the fixation unit. A supporting rod is disposed on a back of the auxiliary mirror and inserted into the connection rod retractably, so that a position and/or an angle of the auxiliary mirror relative to the side view mirror can be adjusted. The connection rod unit further includes an adjustment member. When the auxiliary mirror is adjusted to a required position, the adjustment member can be operated for fixing the supporting rod and the connection rod together.

### BACKGROUND OF THE INVENTION

The present invention relates to an auxiliary mirror device for vehicles and, more particularly, to an auxiliary mirror device for coupling to a vehicle side view mirror.

A conventional way for additionally installing an auxiliary mirror to a vehicle side view mirror is to stick a convex mirror on the vehicle side view mirror for expanding the rear view range. However, because the convex mirror is fixed on the vehicle side view mirror, the driver will be unable to adjust a position and/or an angle of the convex mirror based on the actual conditions to have the most effective rear view angle and range. Furthermore, a size of the convex mirror is normally smaller than half of a size of the vehicle side view mirror. Thus, it will not be very effective for enhancing the rear view range. Additionally, object images reflected on the convex mirror are small which will require the driver to have excellent eyesight to see the object images clearly.

Therefore, an auxiliary mirror device for vehicles is required for improving the above mentioned problems and drawbacks.

### BRIEF SUMMARY OF THE INVENTION

It is an objective of the present invention to provide an auxiliary mirror device for vehicles which can be detachably coupling on a frame of a vehicle side view mirror. The auxiliary mirror device includes an auxiliary mirror. Drivers will be able to adjust a position and/or an angle of the auxiliary mirror relative to the side view mirror based on the actual conditions in order to have the most effective rear view angle and range for enhancing the driving safety.

To achieve this and other objectives, an auxiliary mirror device for vehicles of the present invention includes at least one fixation unit, a connection rod unit, and an auxiliary mirror. The fixation unit includes a fixation base, a clamping member, and a holder base. The fixation base includes a top wall, a bottom wall, and a lateral wall connected between the top and bottom walls. A clamping space is formed between the top and bottom walls, and the top wall has an outer end disposed oppositely to the lateral wall. A vertical screw hole is disposed in the top wall, and a first fixation member is threaded into the vertical screw hole with an inner end of the first fixation member extending into the clamping space. A transverse hole is disposed in the lateral wall, and a second fixation member extends through the transverse hole and the clamping space. The clamping member is movably accommodated in the clamping space of the fixation base in a vertical direction. The clamping member and the bottom wall of the fixation base are adapted for clamping on a frame of a vehicle rear view mirror. An annular wall is formed on an upper face of the clamping member, a recess is formed inside the annular wall, and the inner end of the first fixation member is received in the recess. A plurality of indentations is formed in the annular wall. The holder base includes an annular body with a through-hole extending therethrough, and a gap in communication with the through-hole is formed in the holder base. The holder base includes two opposite clamping walls separated by the gap, and aligned coupling holes are disposed in the two clamping walls respectively. An outer surface of one of the clamping walls abuts against the outer end of the top wall of the fixation base, and the second fixation member is threaded into the coupling holes of the holder base. The connection rod unit includes a connection rod including a first end and a second end spaced from the first end. The first end of the connection rod is received in the through-hole of the holder base and clamped by the clamping walls. A connection hole is provided in the second end of the connection rod. The auxiliary mirror is provided with a supporting rod disposed on a back thereof, and the supporting rod is retractably inserted into the connection hole of the connection rod, so that a position and/or an angle of the auxiliary mirror can be adjusted relative to the side view mirror.

In a preferred form, the auxiliary mirror device further includes an adjustment member. When the auxiliary mirror is adjusted to a required position, the adjustment member can be used for coupling and fixing the supporting rod and the connection rod together.

In a preferred form, the auxiliary mirror device further includes a tightening ring. The second end of the connection rod includes a threading on an outer surface thereof. The adjustment member has a screw hole engageable with the threading of the connection rod. An end of the screw hole of the adjustment member includes a non-threaded recess, and the tightening ring is installed inside the screw hole of the adjustment member. When the adjustment member coupled on the second end of the connection rod is moved towards the first end of the connection rod, the tightening ring will be positioned in the recess and tightened. When the tightening ring is positioned in the recess, the supporting rod can be clamped and fixed by the tightening ring. When the tightening ring is not positioned in the recess, the supporting rod is moveable relative to the connection rod.

The present invention will become clearer in light of the following detailed description of illustrative embodiments of this invention described in connection with the drawings.

### DESCRIPTION OF THE DRAWINGS

FIG. 1 is an exploded, perspective view of an auxiliary mirror device of the present invention.

FIG. 2 is a perspective view of the auxiliary mirror device of FIG. 1.

FIG. 3 is a partial, enlarged perspective view of the auxiliary mirror device of FIG. 2.

FIG. 4 shows a schematic view of the auxiliary mirror device of the present invention being installed to a vehicle side view mirror.

FIG. 5 is a sectional view of the auxiliary mirror device of FIG. 4 installed to the vehicle side view mirror.

FIG. 6 is a schematic view of the auxiliary mirror device of the present invention being installed on another vehicle side view mirror.

FIG. 7 is a partial, sectional view of a connection rod unit of the auxiliary mirror device of the present invention.

FIG. 8 is a schematic view of a position of an auxiliary mirror of the auxiliary mirror device of the present invention being adjusted.

### DETAILED DESCRIPTION OF THE INVENTION

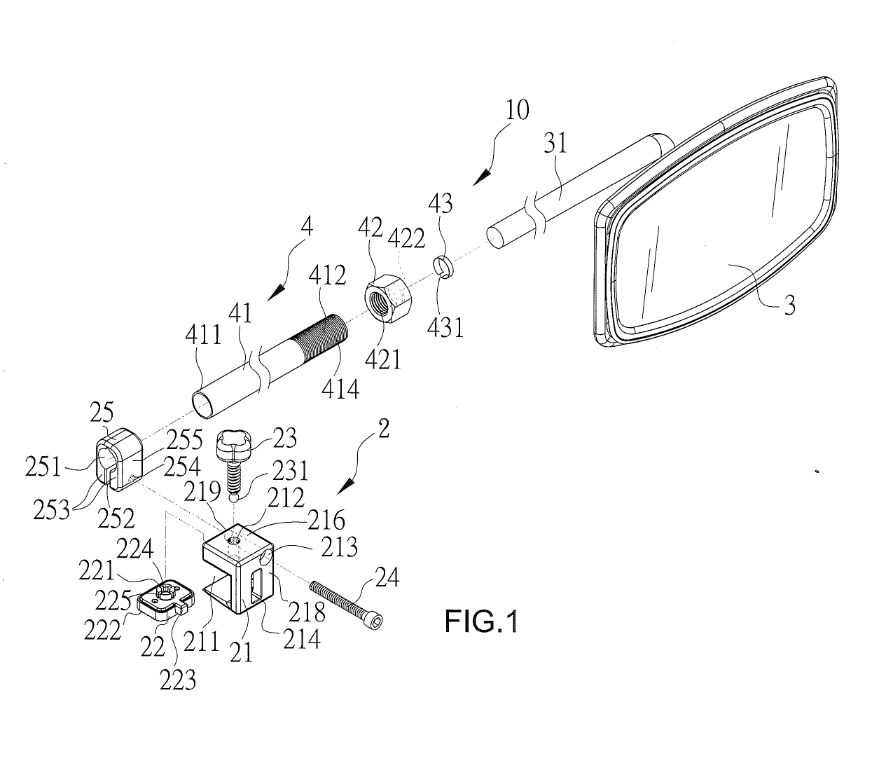

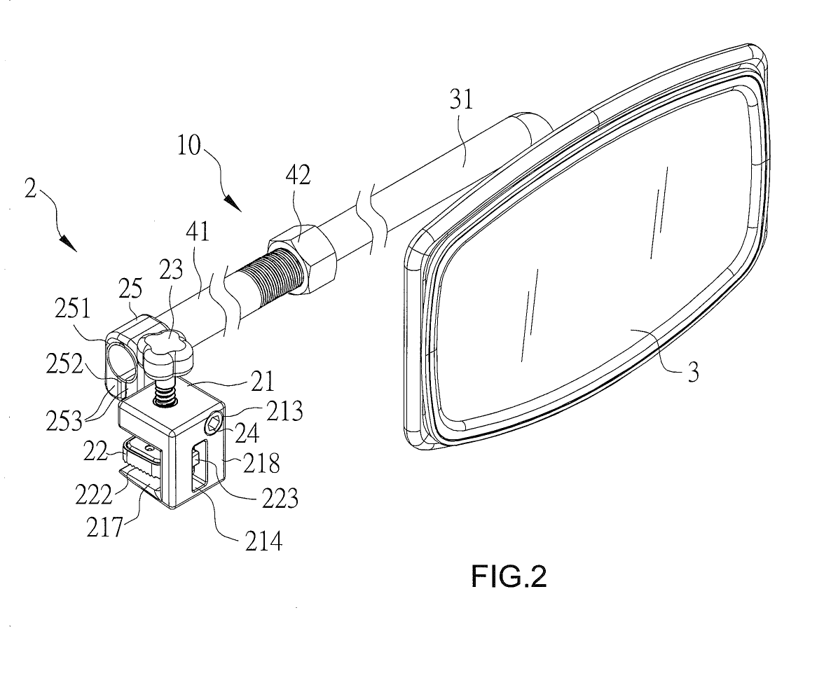

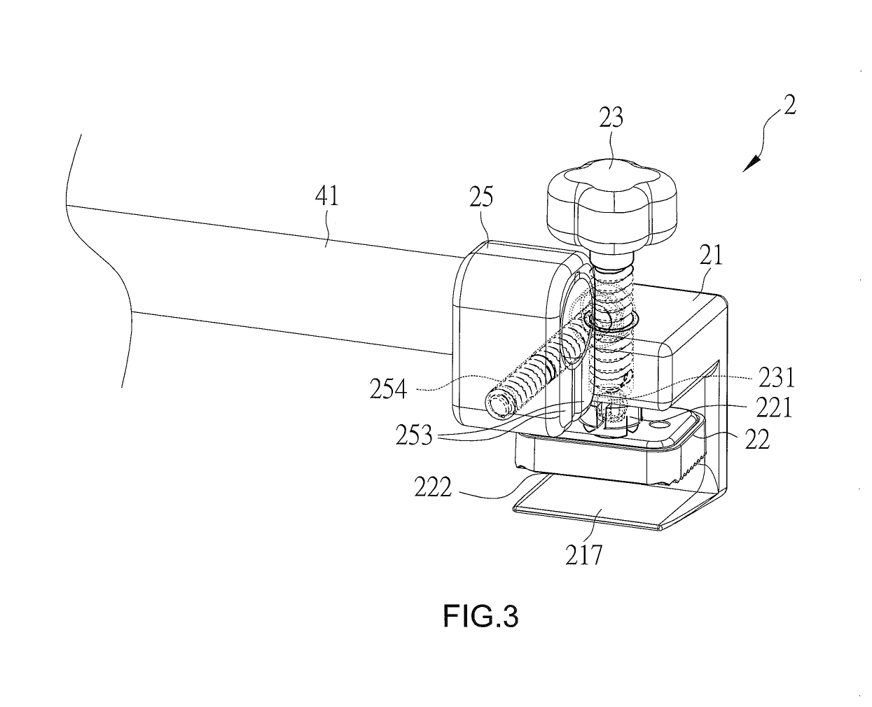

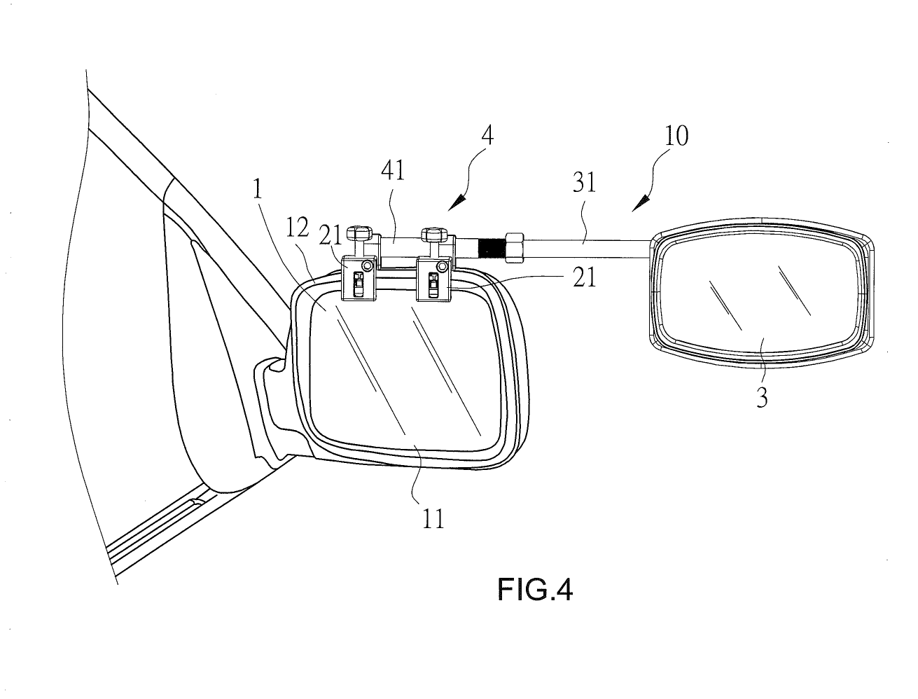

An auxiliary mirror device 10 for vehicles according to a preferred embodiment of the present invention is shown in FIGS. 1 through 3 of the drawings and is adapted for coupling to a vehicle side view mirror 1 (see FIG. 4) to expand a driver's rear view range and enhance the driving safety. The vehicle side view mirror 1 includes a mirror 11 and a frame 12 around the mirror 11.

The auxiliary mirror device 10 includes at least one fixation unit 2, a connection rod unit 4, and an auxiliary mirror 3. The fixation unit 2 includes a fixation base 21, a clamping member 22, and a holder base 25. The fixation base 21 includes a top wall 216, a bottom wall 217, and a lateral wall 218 connected between the top and bottom walls 216 and 217. A clamping space 211 with an opening (not labeled) is formed between the top and bottom walls 216 and 217. The top wall 216 has an outer end 219 disposed oppositely to the lateral wall 218. A vertical screw hole 212 is disposed in the top wall 216, and a first fixation member 23 (e.g. a screw) is threaded into the screw hole 212 with an inner end 231 of the first fixation member 23 extending into the clamping space 211. In this embodiment, the inner end 231 is formed in a ball or conical shape. A transverse hole 213 is disposed in the lateral wall 218, and a second fixation member 24 (e.g. a screw) extends through the transverse hole 213 and the clamping space 211. Furthermore, an elongated vertical slot 214 is further disposed in the lateral wall 218.

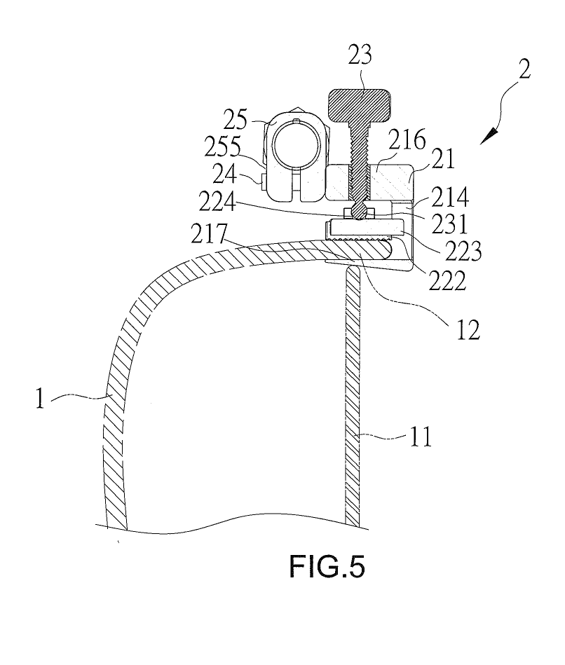

The clamping member 22 is movably accommodated in the clamping space 211 of the fixation base 21 in a vertical direction, so that the clamping member 22 and the bottom wall 217 of the fixation base 21 can be used for clamping on an upper side of the frame 12 of the vehicle rear view mirror 1, as shown in FIGS. 4 and 5. A guiding portion 223 is protruded outwardly from a side of the clamping member 22 and received in the vertical slot 214 of the fixation base 21 for limiting and guiding the clamping member 22 to move vertically inside the clamping space 211. An annular wall 221 is protrudingly formed on an upper face of the clamping member 22. A recess 224 is formed inside the annular wall 221, and a plurality of indentations 225 is disposed in the annular wall 221 and spaced from each other in a circumferential direction thereof. The recess 224 is provided for the inner end 231 of the first fixation member 23 to insert into correspondingly. Furthermore, an indented engaging portion 222 is disposed on a lower face of the clamping member 22.

The holder base 25 is in the form of an annular body having a through-hole 251 extending therethrough. A gap 252 in communication with the through-hole 251 is formed in the holder base 25, so that the holder base 25 includes two opposite clamping walls 253 separated by the gap 252. Aligned coupling holes 254 are disposed in the two clamping walls 253 respectively. Each of the clamping walls 253 has a flat outer surface 255. The outer surface 255 of one of the clamping walls 253 abuts against the outer end 219 of the top wall 216 of the fixation base 21, and the second fixation member 24 extending through the transverse hole 213 is correspondingly inserted and threaded into the coupling holes 254 of the holder base 25, so that the two clamping walls 253 of the holder base 25 can be forced to dispose closer to each other (i.e. a spacing of the gap 252 is reduced).

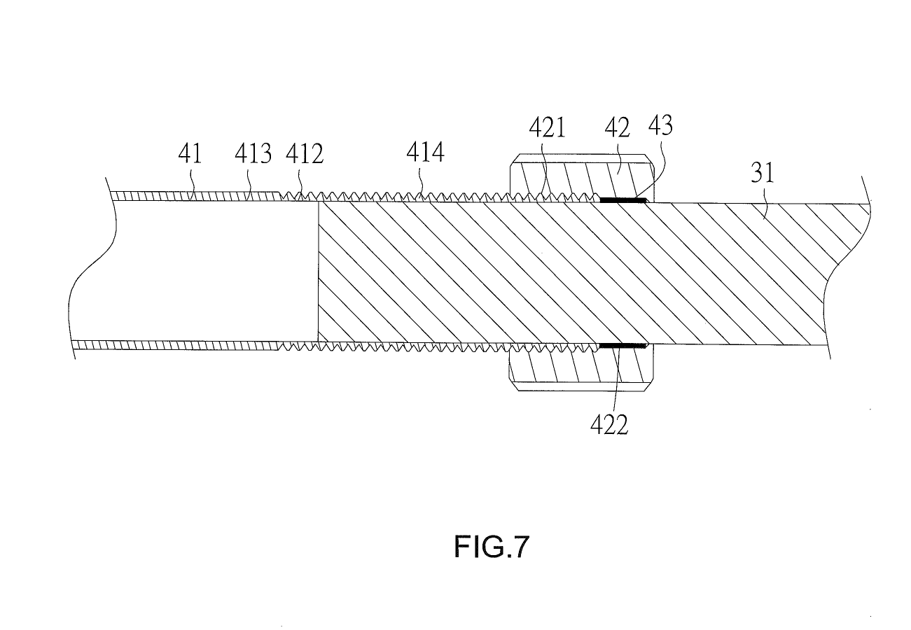

The connection rod unit 4 includes a connection rod 41, an adjustment member 42, and a tightening ring 43. The connection rod 41 includes a first end 411 and a second end 412 spaced from the first end 411 along an axis thereof. The first end 411 of the connection rod 41 is received in the through-hole 251 of the holder base 25 and clamped and fixed by the two clamping walls 253 with the second fixation member 24 threaded and locked into the coupling holes 254 of the holder base 25. A connection hole 413 is provided in the second end 412 of the connection rod 41 (see FIG. 7), and an outer surface of the second end 412 has a threading 414. In this embodiment, the adjustment member 42 is a nut having a screw hole 421 and can be locked with the threading 414 of the connection rod 41 correspondingly. Furthermore, an end of the screw hole 421 of the adjustment member 42 includes a non-threaded recess 422. In this embodiment, the tightening ring 43 is an annular body with an indentation 431 and is installed inside the screw hole 421 of the adjustment member 42. When the adjustment member 42 coupled on the second end 412 of the connection rod 41 is turned and moved towards the first end 411 of the connection rod 41, the tightening ring 43 will be positioned in the recess 422 and tightened (see FIG. 7). When the adjustment member 42 is turned away and loosen from the first end 411, the tightening ring 43 will not be positioned in the recess 422.

The auxiliary mirror 3 is provided with a supporting rod 31 disposed on a back thereof. The supporting rod 31 is inserted into the tightening ring 43 and the connection hole 413 of the connection rod 41. When the tightening ring 43 is positioned in the recess 422 and tightened, the supporting rod 31 will be clamped and fixed by the tightening ring 43. On the other hand, when the tightening ring 43 is not positioned in the recess 422, the supporting rod 31 can be moved relative to the connection rod 41.

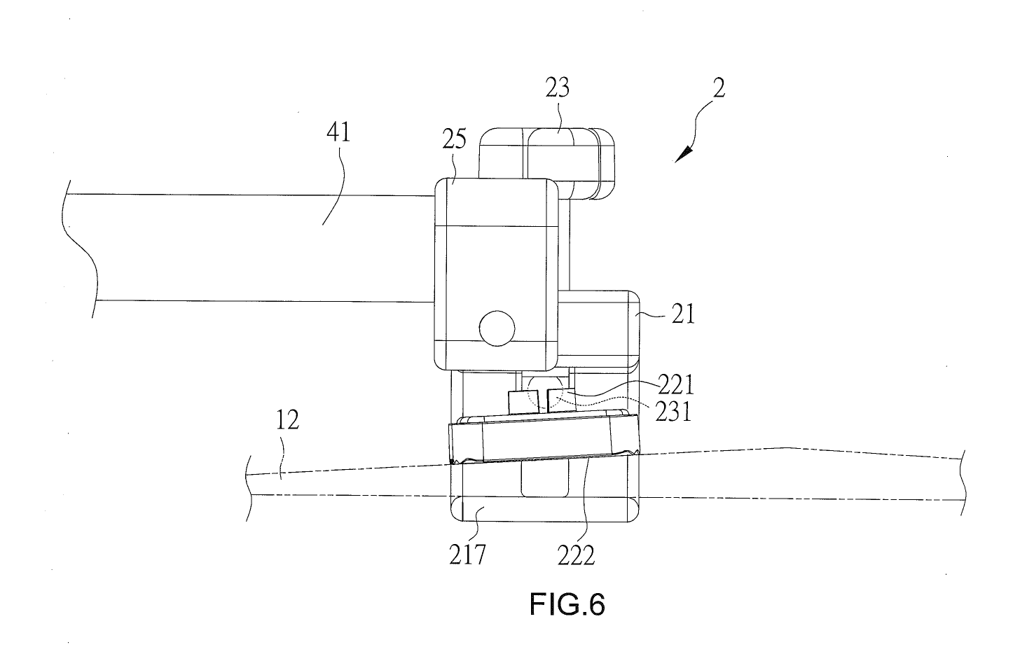

When the auxiliary mirror device 10 of the present invention is embodied, the fixation unit 2 is coupled on the frame 12 of the vehicle side view mirror 1. More specifically, the engaging portion 222 on the lower face of the clamping member 22 and the bottom wall 217 of the fixation base 21 are used for clamping on the upper side of the frame 12 of the vehicle side view mirror 1, as shown in FIGS. 4 and 5. In FIG. 4, two fixation units 2 are used for clamping on the frame 12 of the vehicle side view mirror 1. However, only one fixation unit 2 can be used for clamping on the frame 12. Then, the first fixation member 23 is turned such that the inner end 231 is pressed inside the recess 224 of the clamping member 22, and the first fixation member 23 is locked tightly. Thereby, the fixation base 21 and the clamping member 22 can be fixed on the frame 12, as shown in FIG. 5. Furthermore, with the combination of the conical shaped inner end 231 and the recess 224 as well as the indentations 225 in the annular wall 221, the clamping member 22 can be locked and fixed by the first fixation member 23 in any angles. Therefore, the fixation unit 2 is applicable for installing and fixing on the frame 12 of the vehicle side view mirror 1 with any curvatures, as shown in FIG. 6.

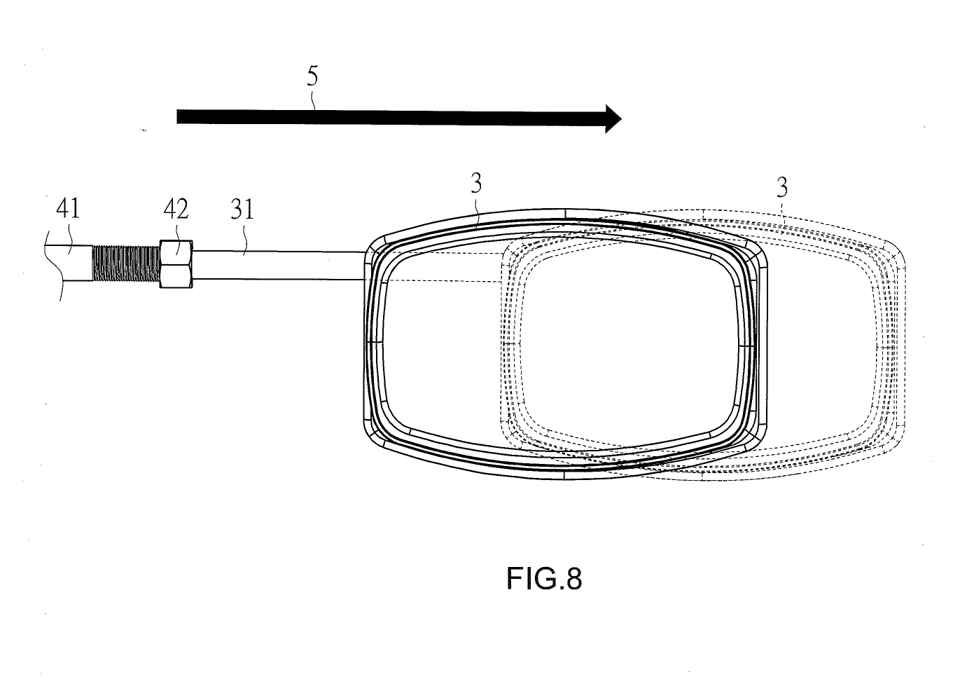

Further, a position and an angle of the auxiliary mirror 3 of the auxiliary mirror device 10 can be adjusted relative to the vehicle side view mirror 1 based on requirements. More specifically, after the adjustment member 42 is loosen, a length of the supporting rod 31 received in the connection hole 413 of the connection rod 41 can be adjusted (as indicated by an arrow 5 in FIG. 8). Additionally, the supporting rod 31 can be turned for changing an angle of the auxiliary mirror 3 relative to the vehicle side view mirror 1, so that the a position and an angle of the auxiliary mirror 3 can be adjusted conveniently. After a position and/or an angle of the auxiliary mirror 3 are adjusted, the adjustment member 42 can be locked tightly again, and the supporting rod 31 will be clamped and fixed by the tightening ring 43. Furthermore, a position of the auxiliary mirror 3 relative to the vehicle side view mirror 1 can also be adjusted by changing a position of the connection rod 41 inside the through-hole 251 of the holder base 25.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An auxiliary mirror device for vehicles comprising:
a fixation unit including a fixation base, a clamping member, and a holder base, with the fixation base including a top wall, a bottom wall, and a lateral wall connected between the top and bottom walls, with a clamping space formed between the top and bottom walls, with the top wall having an outer end disposed oppositely to the lateral wall, with a vertical screw hole disposed in the top wall, with a first fixation member threaded into the screw hole, with an inner end of the first fixation member extending into the clamping space, with a transverse hole disposed in the lateral wall, with a second fixation member extending through the transverse hole and the clamping space, with the clamping member movably accommodated in the clamping space of the fixation base in a vertical direction, with the clamping member and the bottom wall of the fixation base adapted for clamping on a frame of a vehicle rear view mirror, with an annular wall formed on an upper face of the clamping member, with a recess formed inside the annular wall, with the inner end of the first fixation member received in the recess, with a plurality of indentations formed in the annular wall, with the holder base including an annular body having a through-hole extending therethrough, with a gap in communication with the through-hole formed in the holder base, with the holder base further including two opposite clamping walls separated by the gap, with aligned coupling holes disposed in the two clamping walls respectively, with an outer surface of one of the clamping walls abutting against the outer end of the top wall of the fixation base, with the second fixation member threaded into the coupling holes of the holder base;
a connection rod unit including a connection rod, with the connection rod including a first end and a second end spaced from the first end, with the first end of the connection rod received in the through-hole of the holder base and clamped by the clamping walls, with a connection hole provided in the second end of the connection rod; and
an auxiliary mirror provided with a supporting rod disposed on a back thereof, with the supporting rod retractably inserted into the connection hole of the connection rod.

2. The auxiliary mirror device for vehicles according to claim 1, wherein the connection rod unit further includes an adjustment member and a tightening ring, with the second end of the connection rod including a threading on an outer surface thereof, with the adjustment member having a screw hole engageable with the threading of the connection rod, with an end of the screw hole of the adjustment member including a non-threaded recess, with the tightening ring installed inside the screw hole of the adjustment member, wherein when the adjustment member coupled on the second end of the connection rod is moved towards the first end of the connection rod, the tightening ring will be positioned in the recess and tightened; wherein when the tightening ring is positioned in the recess, the supporting rod is clamped and fixed by the tightening ring; wherein when the tightening ring is not positioned in the recess, the supporting rod is moveable relative to the connection rod.

3. The auxiliary mirror device for vehicles according to claim 2, wherein the adjustment member is a nut, with the tightening ring being an annular body having an indentation.

4. The auxiliary mirror device for vehicles according to claim 2, wherein an elongated vertical slot is disposed in the lateral wall of the fixation base, with a guiding portion protruded outwardly from a side of the clamping member and received in the vertical slot of the fixation base.

5. The auxiliary mirror device for vehicles according to claim 2, wherein the inner end of the first fixation member is formed in a ball or conical shape, with an indented engaging portion disposed on a lower face of the clamping member.

6. The auxiliary mirror device for vehicles according to claim 2, wherein each of the first and second fixation members is a screw.
